(19) United States
(12) Patent Application Publication
(10) Pub. No.: US 2009/0188439 A1
(43) Pub. Date: Jul. 30, 2009

(54) CONVERTIBLE SCRATCHING APPARATUS FOR PETS

(75) Inventors: Jeffrey M. SIMPSON, Auburn, AL (US); Gary L. ROCKWELL, Auburn, AL (US)

Correspondence Address: GARDNER GROFF GREENWALD & VILLANUEVA. PC, 2018 POWERS FERRY ROAD, SUITE 800, ATLANTA, GA, 30339, US

(73) Assignee: Jeffrey M. SIMPSON, Auburn, AL (US)

(21) Appl. No.: 12/022,635

(22) Filed: Jan. 30, 2008

(51) Int. Cl. A01K 15/00

(52) U.S. Cl. 119/706

(57) ABSTRACT

A convertible scratching apparatus for a cat or other pet includes a frame and a panel having a scratching surface thereon. The panel is selectively positionable relative to the frame so that a user can orient the scratching surface horizontally, vertically or at an angle, depending on the user's or the pet's preference. Optionally, a second panel is provided with a second scratching surface and braces the first panel in an erected configuration.

### TECHNICAL FIELD

The present invention relates generally to the field of pet products.

### BACKGROUND OF THE INVENTION

There are millions of households in the United States and throughout the world that keep domesticated cats. One of the issues with domesticated cats is their tendency to want to scratch on household items as a means of keeping their claws sharp and maintained. This is a problem for domestic cat owners as cats typically scratch on furniture and rugs or carpets to maintain their claws, and can cause damage to these items.

To mitigate this problem, cat owners often purchase scratching implements for their cats. There are various forms and types of scratching implements currently on the market, typically falling into two categories: short term use products and long term use products. Short term use products are typically made of corrugated paper materials, whereas long term use products are typically made of a wood or bonded paper structure with a carpet covering. Both short and long term use products come in vertical, horizontal and angled forms. Some of the horizontal forms also allow the product to be suspended from a door knob or the like, so as to create a vertical scratching surface. Typical angled forms do not allow vertical or horizontal positioning.

In many applications, however, known scratching implements do not meet the needs of some users, may be difficult to move or store, and/or cannot be used in differing manners that a pet or owner may find desirable. Continuing development in the field would be advantageous. It is to the provision of an improved scratching implement for cats and other pets that the present invention is primarily directed.

### SUMMARY OF THE INVENTION

In example embodiments, the present invention provides an improved scratching apparatus for cats and other pets that is selectively convertible or collapsible. The scratching apparatus of the present invention allows a user to selectively position the scratching surface(s) of the scratching device in horizontal, vertical or angled positions, thus allowing a single apparatus to fulfill multiple different positional orientations for a pet to scratch.

In one aspect, the present invention is a scratching apparatus for a pet. The scratching apparatus includes a frame and a first pivotal member having a first end pivotally mounted to the frame and a second end opposite the first end. The first pivotal member includes a panel having a scratching material along at least a portion thereof. The first pivotal member is pivotally movable between a collapsed configuration and an erected configuration.

In another aspect, the invention is a convertible scratching apparatus for a pet, including a frame and at least one scratching surface. The apparatus is convertible between a collapsed configuration wherein the at least one scratching surface is aligned with the frame, and an erected configuration wherein the at least one scratching surface is oriented obliquely relative to the frame.

In still another aspect, the invention is a convertible scratching apparatus for pets. The apparatus includes a generally rectangular frame having first and second sides and first and second ends. The frame bounds and defines an inner space between the first and second sides and between the first and second ends, the inner space having a length, a width and a depth. The apparatus also includes a first panel having a proximal end pivotally connected to the first and second sides of the frame proximal the first end of the frame, and having a scratching surface thereon, wherein the first panel has a first panel length and a first panel width less than the length and width of the inner space.

In another aspect, the invention is a method of positioning a scratching surface for a pet, the method including providing a scratching apparatus having a frame and a scratching surface, and selectively positioning the scratching surface relative to the frame.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a perspective view of a convertible scratching apparatus according to an example form of the present invention, shown in its erected configuration.

FIG. 2 is a perspective view of the collapsible scratching apparatus of FIG. 1, shown in its collapsed configuration.

FIGS. 3-8 show a sequence of operation of the collapsible scratching apparatus of FIG. 1, between the collapsed configuration of FIG. 2 and the erected configuration of FIG. 1.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other references identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

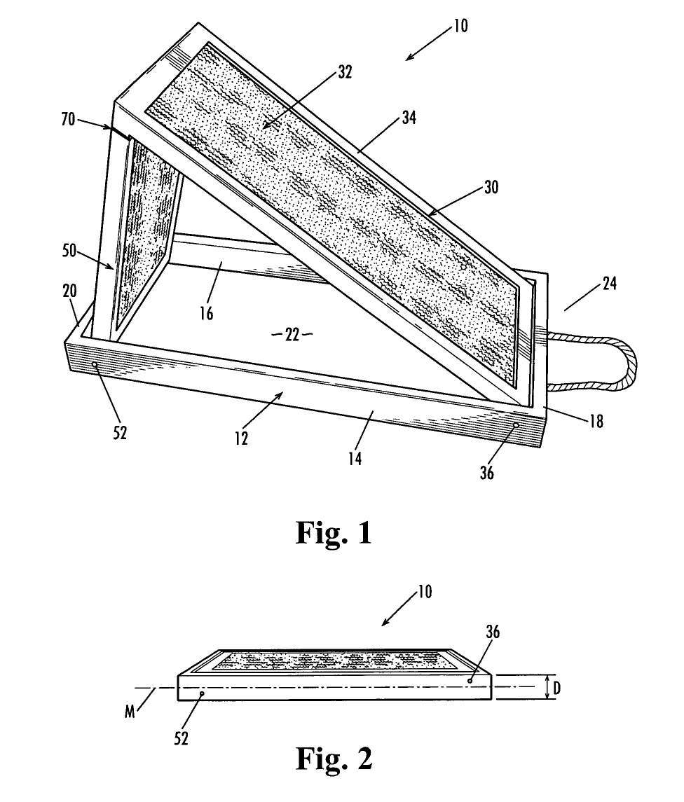

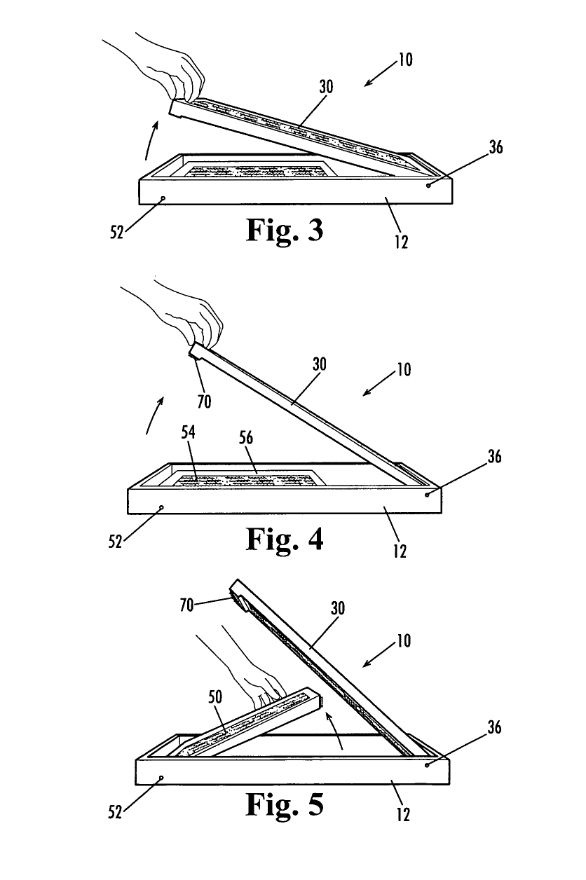

With reference now to the drawing figures, wherein like reference numbers represent corresponding parts throughout the several views, FIG. 1 shows a collapsible/extensible or convertible scratching apparatus or platform 10 for use by cats, dogs, ferrets, rabbits, or other pets and animals that are prone to scratching objects. The scratching apparatus 10 generally comprises an outer frame 12, a first pivoting member 30, and a second pivoting member 50, whereby the first and second pivoting members can move between a collapsed configuration (see FIG. 2) and an erected configuration (see FIG. 1).

The outer frame 12 of the scratching apparatus 10 comprises first and second sides 14, 16 that define the lengthwise dimension of the apparatus, and first and second ends 18, 20 that define the widthwise dimension of the apparatus, arranged in rectangular form to define and bound a generally rectangular inner contained space 22. In example forms, the first and second sides 14, 16 and first and second ends 18, 20 comprise wood, plastic or other substantially rigid material, and are joined by nails, screws, staples, adhesives or other fastening means, or alternatively comprise portions of an integral or unitary frame. The frame optionally comprises a bottom panel and/or one or more feet or base pads of felt, rubber, plastic or other non-marring and/or non-slip material for supporting the scratching platform 10 upon a floor or other supporting structure.

A loop, hook, hanger, bracket or other support means is optionally affixed to the frame. In the depicted embodiment, a rope loop 24 extends externally from the frame 12 and is attached to the first end 18 by extending the ends of a segment of rope through a pair of spaced holes or openings in the first end 18 and knotting the ends on the interior side of the frame within the inner contained space 22. The rope loop 24 is preferably attached at or below a medial axis or plane M extending along the width of the frame 12 midway between the upper and lower edges of the end 18 when positioned as in FIG. 1, and generally midway along the frame's width.

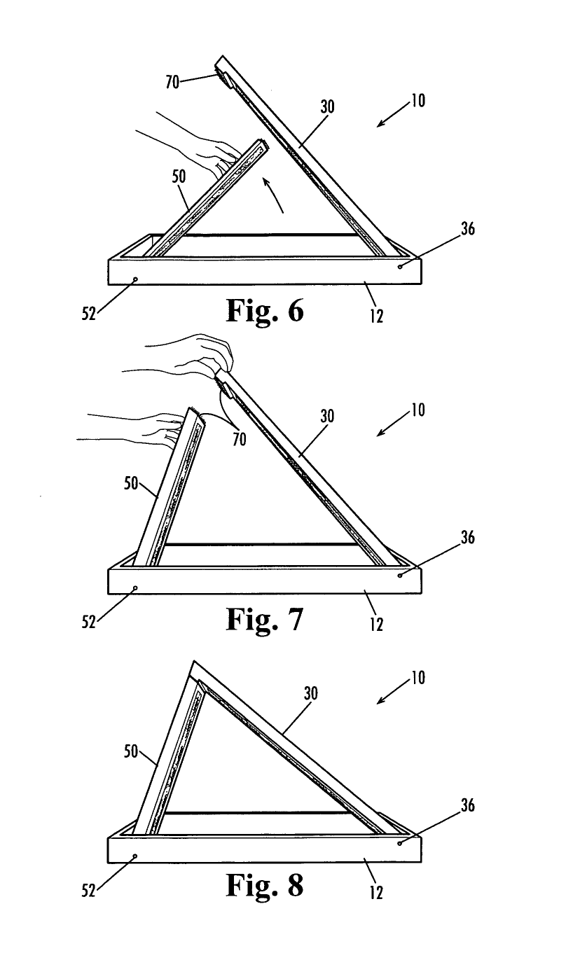

In the depicted embodiment, the first pivoting member 30 comprises a generally rectangular panel including a first section of carpet, fabric, cardboard, or other scratching surface material 32, that is permanently or removably mounted to an outer face of a support frame or base 34. The first pivoting member 30 is pivotally connected to the outer frame 12 of the scratching apparatus 10 by a first hinge or pin connection 36 at a first or proximal connected end of the first pivoting member, and has an opposite second or distal free end that pivots or rotates about the hinged connection into (see FIG. 2) and out of (see FIGS. 3-8) the inner contained space 22 of the frame. The points of connection of the hinge or pin connection 36 with the frame 12 are preferably located on the first and second sides 14, 16 proximal the first end 18, providing sufficient clearance between the frame 12 and the first pivoting panel 30 for the desired range of movement.

In similar fashion, in the depicted embodiment, the second pivoting member 50 comprises a generally rectangular panel that is pivotally connected to the outer frame 12 of the scratching apparatus 10 by a second hinge or pin connection 52 at a first or proximal connected end of the second pivoting member, and has an opposite second or distal free end that pivots or rotates about the hinged connection into (see FIGS. 2-4) and out of (see FIGS. 5-8) the inner contained space 22. The points of connection of the second hinge or pin connection 52 with the frame 12 are preferably located on the first and second sides 14, 16 proximal the second end 20, on the opposite end of the frame from the first hinge or pin connection 36. The second pivoting member 50 optionally also includes a second section of carpet, fabric, cardboard, or other scratching surface material 54 that is permanently or removably mounted to an outer face of a support frame or base 56. Alternatively, the second pivoting member 50 is simply a post or panel serving as a brace for supporting the first pivoting member 30 in the erected configuration of the scratching apparatus 10.

Optionally, one or both of the hinge connections 36, 52 comprise retractable pins or other releasable connection means, whereby one or both of the pivoting members 30, 50 can be removed and replaced, for example to replace a worn out scratching surface with a fresh one. Additionally or alternatively, replaceable scratching pad inserts can be provided for installation and removal within the support frame or base of one or both pivoting members. In further embodiments of the invention, one or both of the pivoting members 30, 50 are reversible, having carpet or other scratching surface material on both faces thereof. In this manner, if the scratching surface material on the outer face becomes excessively worn, the panel can be detached and flipped over to expose the material originally on the inner face for use. Optionally, the scratching surface materials on the inner and outer faces are of different colors, whereby the panel(s) can be reversibly flipped for aesthetic purposes to compliment surrounding décor.

In example forms of the invention, the first pivoting member 30 has a first length and the second pivoting member 50 has a second length (both lengths being defined as the distance between the proximal or connected ends and the distal or free ends of the respective members), both lengths being less than the length of the inner contained space 22 of the frame 12 (measured between interior faces of the first end 18 and the second end 20); and the first length being greater than the second length, and more preferably the first length being at least about 1.5 to 2.0 times the second length.

The thicknesses of the first pivoting member 30 and the second pivoting member 50 are preferably no more than about one-half the depth D of the frame 12, so that they can be folded into the inner contained space 22 and substantially contained within the frame in the device's collapsed configuration (see FIG. 2). The points of connection of the first hinge or pin connection 36 with the frame 12 are preferably located above the medial axis or plane M extending along or through the frame midway between the upper and lower edges of the frame when positioned as in FIG. 1, most preferably at a distance of about 0.25 D from the upper edge of the frame. The points of connection of the second hinge or pin connection 52 with the frame 12 are preferably located below the medial axis or plane M, most preferably at a distance of about 0.25 D from the lower edge of the frame. In this manner, in the device's collapsed configuration (see FIG. 2) the outer face of the first pivoting member 30 is generally parallel and coplanar with the upper edges of the frame 12, and the lower face of the second pivoting member 50 is generally parallel and coplanar with the lower edges of the frame 12, forming a compact and generally rectangular prismatic body.

The free end(s) of the first pivoting member 30 and/or the second pivoting member 50 preferably include one or more releasable coupling component(s) 70 such as one or more compression fit pins, interengaging hook-and-loop fastener elements (Velcro), magnetic couplings, or other detachable fastener(s) for rigidly securing the pivoting members in the erected configuration. The frame 12 optionally includes one or more stop members for preventing or limiting pivotal movement of the first pivoting member 30 and/or the second pivoting member 50 beyond a desired range of motion.

The device 10 of the present invention allows selective positioning of its one or more scratching surface panels 32, 54 in the horizontal, vertical or angled positions thus allowing one product to fulfill any cat's or cat owner's preferred positioning for a scratching surface. For example, to use the device 10 with the scratching surface 32 in a horizontal position, the device is placed on a solid horizontal surface, preferably a floor, and arranged in its collapsed configuration with both pivoting panels folded into the frame (see FIG. 2). To use the device 10 with the scratching surface 32 in a vertical position, the device is suspended by loop 24 from a doorknob, hook, nail or other support element. To use the device 10 with first scratching surface 32 and/or second scratching surface 54 in an angled position, the device is erected from its collapsed state as shown in FIGS. 3-8 by raising the first pivoting member 30 and the second pivoting member 50 about their hinged axes, and coupling the free ends together. In the erected configuration, the first pivoting member 30 is preferably oriented at an oblique angle of about 15°-75°, and more preferably about 30°-45°, relative to the medial plane of the frame 12; and the second pivoting member 50 is preferably oriented at an angle of about 30°-90° relative to the medial plane of the frame 12. The device may be collapsed from its erected configuration by reversing the sequence of FIGS. 2-8.

While the invention has been described with reference to preferred and example embodiments, it will be understood by those skilled in the art that a variety of modifications, additions and deletions are within the scope of the invention, as defined by the following claims.

What is claimed is:

1. A scratching apparatus for a pet, comprising:
a frame, and
a first pivotal member having a first end pivotally mounted to the frame and a second end opposite the first end, the first pivotal member comprising a panel having a scratching material along at least a portion thereof;
wherein the first pivotal member is pivotally movable between a collapsed configuration and an erected configuration.

2. The scratching apparatus of claim 1, further comprising a second pivotal member for holding the first pivotal member in the erected configuration.

3. The scratching apparatus of claim 2, wherein the second pivotal member comprises a second panel having a scratching material along at least a portion thereof.

4. The scratching apparatus of claim 2, wherein the first pivotal member is hingedly attached proximal a first end of the frame and the second pivotal member is hingedly attached proximal a second end of the frame opposite the first end.

5. The scratching apparatus of claim 2, wherein the first pivotal member is attached to the frame above a medial plane of the frame, and wherein the second pivotal member is attached to the frame below the medial plane of the frame.

6. The scratching apparatus of claim 2, further comprising at least one releasable coupling between the first pivotal member and the second pivotal member for securing the apparatus in the erected configuration.

7. The scratching apparatus of claim 1, wherein the first pivotal member is substantially within an inner contained space of the frame in the collapsed configuration.

8. The scratching apparatus of claim 1, wherein the first pivotal member is oriented at an acute angle relative to the frame in the erected configuration.

9. The scratching apparatus of claim 8, wherein the acute angle is between 15°-75°.

10. The scratching apparatus of claim 1, wherein the scratching material is carpet.

11. The scratching apparatus of claim 1, further comprising a mounting loop affixed to a first end of the frame.

12. The scratching apparatus of claim 1, wherein the first pivotal member is releasably coupled to the frame.

13. The scratching apparatus of claim 1, wherein the panel of the first pivotal member is reversible and has scratching material on inner and outer faces thereof.

14. A convertible scratching apparatus for a pet, said convertible scratching apparatus comprising:
a frame; and
at least one scratching surface;
wherein the apparatus is convertible between a collapsed configuration wherein the at least one scratching surface is aligned with the frame, and an erected configuration wherein the at least one scratching surface is oriented obliquely relative to the frame.

15. The convertible scratching apparatus of claim 14, comprising a first scratching surface and a second scratching surface, wherein each of the first and second scratching surfaces are aligned with the frame in the collapsed configuration, and wherein at least the first scratching surface is oriented obliquely relative to the frame in the erected configuration.

16. The convertible scratching apparatus of claim 15, wherein the first scratching surface is carried on a first pivotal member hingedly mounted adjacent a first end of the frame and wherein the second scratching surface is carried on a second pivotal member hingedly mounted adjacent a second end of the frame opposite the first end.

17. The convertible scratching apparatus of claim 16, wherein the first pivotal member is attached above a medial plane of the frame and wherein the second pivotal member is attached below the medial plane of the frame.

18. The convertible scratching apparatus of claim 14, wherein the at least one scratching surface is positioned within an inner contained space of the frame in the collapsed configuration.

19. The convertible scratching apparatus of claim 14, further comprising a support member affixed to the frame, whereby the frame can be hung such that the at least one scratching surface is positioned vertically when the apparatus is in its collapsed configuration.

20. The convertible scratching apparatus of claim 14, wherein the at least one scratching surface is releasably coupled to the frame.

21. The convertible scratching apparatus of claim 14, wherein the at least one scratching surface comprises a first scratching surface on an outer face of a panel reversibly attached to the frame, and a second scratching surface on an inner face of the panel.

22. A convertible scratching apparatus for pets comprising:
a generally rectangular frame having first and second sides and first and second ends, said frame bounding and defining an inner space between the first and second sides and between the first and second ends, said inner space having a length, a width and a depth; and
a first panel having a proximal end pivotally connected to the first and second sides of the frame proximal the first end of the frame, and having a scratching surface thereon, wherein the first panel has a first panel length and a first panel width less than the length and width of the inner space.

23. The convertible scratching apparatus of claim 22, further comprising a second panel having a proximal end pivotally connected to the first and second sides proximal the second end, and having a scratching surface thereon.

24. The convertible scratching apparatus of claim 23, wherein the second panel has a second panel length less than the first panel length.

25. The convertible scratching apparatus of claim 23, wherein the first and second panels each have a thickness of less than one-half the depth of the inner space of the frame.

26. The convertible scratching apparatus of claim 23, wherein the first panel is attached to the frame at a distance of about 0.25 the depth of the inner space of the frame from a top edge of the frame, and wherein the second panel is attached to the frame at a distance of about 0.25 the depth of the inner space of the frame from a bottom edge of the frame.

27. The convertible scratching apparatus of claim 23, wherein the first and second panels are releasably attached to the frame.

28. The convertible scratching apparatus of claim 23, wherein the first and second panels are reversible and have scratching surfaces on inner and outer faces thereof.

29. A method of positioning a scratching surface for a pet, said method comprising providing a scratching apparatus having a frame and a scratching surface, and selectively positioning the scratching surface relative to the frame.
